(19) United States
(12) Patent Application Publication
(10) Pub. No.: US 2024/0300320 A1
(43) Pub. Date: Sep. 12, 2024

(54) HEAT MANAGEMENT SYSTEM

(71) Applicant: TOYOTA JIDOSHA KABUSHIKI KAISHA, Toyota-shi (JP)

(72) Inventor: Tomoaki SUZUKI, Nagoya-shi (JP)

(73) Assignee: TOYOTA JIDOSHA KABUSHIKI KAISHA, Toyota-shi (JP)

(21) Appl. No.: 18/598,196

(22) Filed: Mar. 7, 2024

(30) Foreign Application Priority Data
Mar. 9, 2023 (JP) 2023-036654

(51) Int. Cl. B60K 11/08; B60H 1/00; B60H 1/32; B60L 58/26; H01M 10/48; H01M 10/615; H01M 10/625; H01M 10/63; H01M 10/6568; H01M 10/663

(52) U.S. Cl. CPC B60K 11/085; B60H 1/00278; B60H 1/00385; B60H 1/32284; B60L 58/26; H01M 10/486; H01M 10/615; H01M 10/625; H01M 10/63; H01M 10/6568; H01M 10/663; B60H 2001/00307; H01M 2220/20

(57) ABSTRACT

A heat management system has: a first flow passage, a second flow passage, a third flow passage, and a fourth flow passage; an electrical storage device configured to perform heat exchange with a heat medium in the first flow passage; a driving device configured to perform heat exchange with a heat medium in the second flow passage; a radiator provided in the third flow passage; a chiller device provided in the fourth flow passage; and a switching device. When a temperature of the electrical storage device is raised, the switching device is configured to cause a temperature raising circuit to be formed, the temperature raising circuit being a flow passage circuit in which a connection flow passage connecting the first flow passage, the second flow passage, and the third flow passage to one another is provided, with the fourth flow passage being independent of the connection flow passage.

### CROSS-REFERENCE TO RELATED APPLICATION

This application claims priority to Japanese Patent Application No. 2023-036654 filed on Mar. 9, 2023, incorporated herein by reference in its entirety.

### BACKGROUND

### 1. Technical Field

This disclosure relates to a heat management system.

### 2. Description of Related Art

Japanese Unexamined Patent Application Publication No. 2010-272395 discloses an electrified vehicle. This electrified vehicle includes an electrical storage device (battery), an inverter, a motor, and a control device. The electrical storage device is connected to the inverter. The inverter is connected to the motor. The control device controls a current in the electrical storage device by switching control of the inverter. Thus, the control device controls heat that is generated due to an electricity loss caused by internal resistance of the electrical storage device. As a result, the control device can execute temperature raising control of raising the temperature of the electrical storage device using the current in the electrical storage device (temperature raising of the electrical storage device by itself).

### SUMMARY

In electrical apparatus, such as an electrified vehicle, it is sometimes desirable to effectively use heat from a driving device including an inverter and a motor. Further, it is desirable to efficiently execute temperature raising of an electrical storage device. Thus, it is desirable to efficiently execute temperature raising of the electrical storage device while allowing effective utilization of heat generated from the driving device.

This disclosure provides a heat management system that makes it possible to efficiently execute temperature raising of an electrical storage device while allowing effective utilization of heat generated from a driving device.

A heat management system according to a first aspect of this disclosure is provided in an electrical apparatus. The heat management system includes: a first flow passage, a second flow passage, a third flow passage, and a fourth flow passage configured such that a heat medium flows through the first flow passage, the second flow passage, the third flow passage, and the fourth flow passage; an electrical storage device configured to perform heat exchange with the heat medium in the first flow passage; a driving device configured to perform heat exchange with the heat medium in the second flow passage and configured to generate a driving force; a radiator provided in the third flow passage; a chiller device provided in the fourth flow passage; and a switching device configured to switch a connection state among the first flow passage, the second flow passage, the third flow passage, and the fourth flow passage. When a temperature of the electrical storage device is raised, the switching device is configured to cause a temperature raising circuit to be formed. The temperature raising circuit is a flow passage circuit in which a connection flow passage connecting the first flow passage, the second flow passage, and the third flow passage to one another is provided, with the fourth flow passage being disconnected from and independent of the connection flow passage.

In the heat management system according to the first aspect of this disclosure, as described above, when the temperature of the electrical storage device is raised, the connection flow passage connecting the first flow passage, the second flow passage, and the third flow passage to one another and the fourth flow passage are disconnected from and independent of each other. Thus, the temperature of the electrical storage device can be raised using heat generated in the driving device. Moreover, the heat generated in the driving device and heat due to heat generation of the electrical storage device by itself are less likely to be taken away by the chiller device that has no relation to temperature raising of the electrical storage device. As a result, it is possible to efficiently execute temperature raising of the electrical storage device while allowing effective utilization of the heat generated from the driving device.

In the heat management system according to the first aspect of this disclosure, the electrical apparatus may be an electrified vehicle. The temperature of the electrical storage device may be raised after start-up of a travel system of the electrified vehicle. This configuration makes it possible to easily bring the electrical storage device to a high temperature at the start of travel of the electrified vehicle. As a result, at the start of travel of the electrified vehicle, the travel performance of the electrified vehicle can be easily brought to a certain level or higher.

In the heat management system according to the first aspect of this disclosure, the electrical storage device may be configured such that external charging is performed, the external charging being a charging in which the electrical storage device is charged with charging electricity supplied from a charging facility outside the electrical apparatus. The temperature of the electrical storage device may be raised such that the temperature of the electrical storage device is equal to or higher than a predetermined temperature at start of the external charging. This configuration makes it possible to easily bring the electrical storage device to a high temperature at the start of the external charging. As a result, at the start of the external charging, the charging speed and the charging efficiency can be easily brought to a certain level or higher. “The start of the external charging” may be a timing when charging electricity starts to be supplied to the electrical storage device.

The heat management system according to the first aspect of this disclosure may further include a first temperature sensor configured to detect the temperature of the electrical storage device, and a second temperature sensor configured to detect the temperature of the heat medium in the second flow passage. The switching device may be configured to cause the temperature raising circuit to be formed, when the temperature of the electrical storage device is raised and a detection value of the second temperature sensor is larger than a detection value of the first temperature sensor. This configuration makes it less likely that the electrical storage device may be cooled by the heat medium in the second flow passage.

The heat management system according to the first aspect of this disclosure may further include a pump that is provided in the second flow passage and configured to circulate the heat medium. The output of the pump may be increased as time passes when the temperature of the electrical storage device is raised in a state where the temperature raising circuit is provided. This configuration makes it possible to increase the output of the pump after the heat medium in the second flow passage reaches a relatively high temperature as time passes. As a result, the electrical storage device is less likely to be cooled by the heat medium.

In the heat management system according to the first aspect of this disclosure, the electrical apparatus may be an electrified vehicle. The chiller device may be configured to exchange heat with an air conditioning circuit that is configured to adjust a temperature in a cabin of the electrified vehicle. When there is no request for heating using the air conditioning circuit, the temperature of the electrical storage device may be raised in a state where the temperature raising circuit is provided. This configuration makes it less likely that the heat of the driving device and the electrical storage device may be taken away by the radiator, the chiller device, etc., as there is no request for heating. As a result, it is possible to more effectively utilize the heat generated from the driving device, as well as to more efficiently execute temperature raising of the electrical storage device.

In the heat management system according to the first aspect of this disclosure, the chiller device may be configured to exchange heat with an air conditioning circuit that is configured to adjust a temperature in a cabin of the electrified vehicle, and when there is no request for heating using the air conditioning circuit, the temperature of the electrical storage device may be raised in a state where the temperature raising circuit is provided.

The heat management system according to the first aspect of this disclosure may further include a grille shutter that is configured to open and close and configured to adjust the amount of heat released from the radiator to the outside of the electrified vehicle. The electrical apparatus may be an electrified vehicle. The grille shutter may be put in a closed state when the temperature of the electrical storage device is raised in a state where the temperature raising circuit is provided. This configuration makes it less likely that the heat of the driving device and the electrical storage device may escape to the outside through the grille shutter.

The heat management system according to the first aspect of this disclosure may further include a grille shutter that is configured to open and close and configured to adjust the amount of heat released from the radiator to the outside of the electrified vehicle. The grille shutter may be put in a closed state when the temperature of the electrical storage device is raised in a state where the temperature raising circuit is provided.

The heat management system according to the first aspect of this disclosure may further include a control device configured to control the switching device.

According to this disclosure, it is possible to efficiently execute temperature raising of an electrical storage device while allowing effective utilization of heat generated from a driving device.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a view showing an electrified vehicle in which a heat management system according to one embodiment is installed;

FIG. 2 is a diagram showing the configuration of the heat management system according to the embodiment;

FIG. 3 is a diagram showing the detailed configuration of the heat management system according to the embodiment;

FIG. 4 is a view showing a first communication pattern of a heat management circuit according to the embodiment;

FIG. 5 is a view showing a second communication pattern of the heat management circuit according to the embodiment;

FIG. 6 is a flowchart showing control of the heat management system according to the embodiment;

FIG. 7 is a flowchart showing detailed control in step S160 of FIG. 6;

FIG. 8 is a flowchart showing detailed control in step S180 of FIG. 6;

FIG. 9 is a flowchart showing control of the heat management system according to a modified example of the embodiment;

FIG. 10 is a diagram showing the configuration of a heat management system according to a modified example of the embodiment; and

FIG. 11 is a diagram showing a circuit configuration including a battery, a converter, an inverter, and a motor.

### DETAILED DESCRIPTION OF EMBODIMENTS

An embodiment of this disclosure will be described in detail below with reference to the drawings. The same or corresponding parts in the drawings will be denoted by the same reference sign and description thereof will not be repeated.

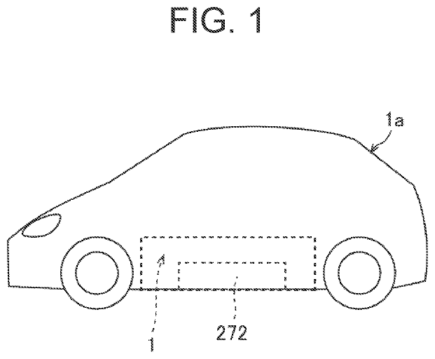

In the following, a configuration in which a heat management system according to this disclosure is installed in an electrified vehicle 1a (see FIG. 1) will be described as an example. The electrified vehicle 1a may be a vehicle equipped with a battery 272 for traveling and is, for example, a battery electric vehicle (BEV). The electrified vehicle 1a may be a hybrid electric vehicle (HEV), a plug-in hybrid electric vehicle (PHEV), or a fuel cell electric vehicle (FCEV). However, application of the heat management system according to this disclosure is not limited to vehicles. The electrified vehicle 1a is one example of “electrical apparatus” of this disclosure.

### Overall Configuration

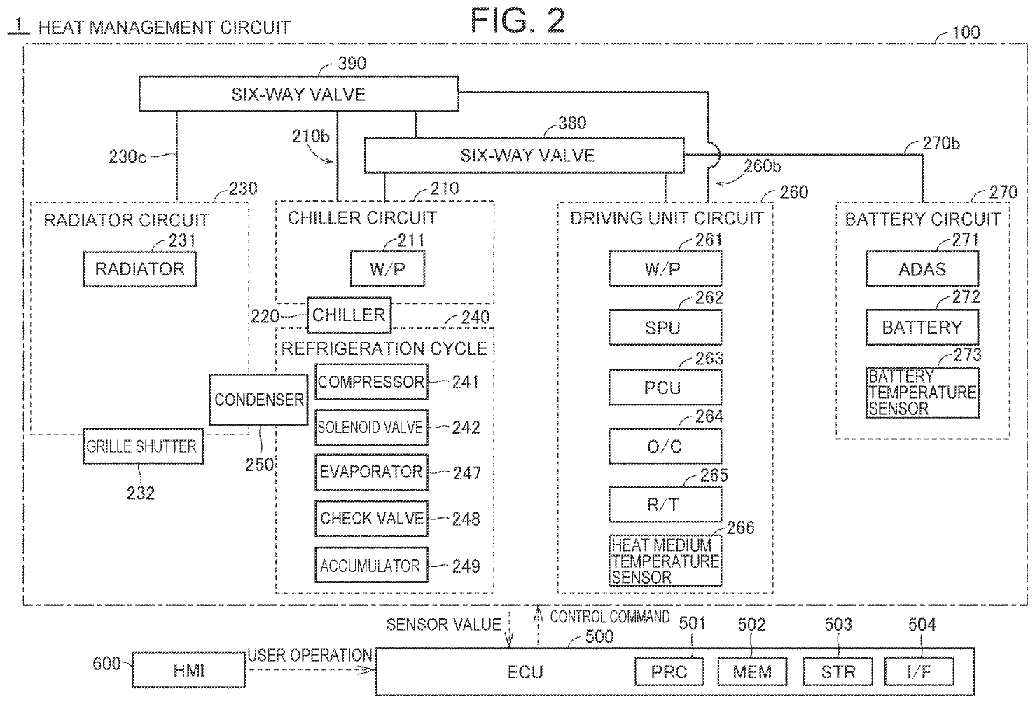

FIG. 2 is a diagram showing one example of the overall configuration of a heat management system 1 according to the embodiment of this disclosure. The heat management system 1 includes a heat management circuit 100, an electronic control unit (ECU) 500, and a human-machine interface (HMI) 600.

The heat management circuit 100 includes, for example, a chiller circuit 210, a chiller 220, a radiator circuit 230, a refrigeration cycle 240, a condenser 250, a driving unit circuit 260, a battery circuit 270, a six-way valve 380, and a six-way valve 390. Each of the six-way valve 380 and the six-way valve 390 is one example of “switching device” of this disclosure. The chiller 220 and the refrigeration cycle 240 are examples of “chiller device” and “air conditioning circuit,” respectively, of this disclosure.

The chiller circuit 210 includes a water pump (W/P) 211. The chiller 220 is connected to (shared by) both of the chiller circuit 210 and the refrigeration cycle 240.

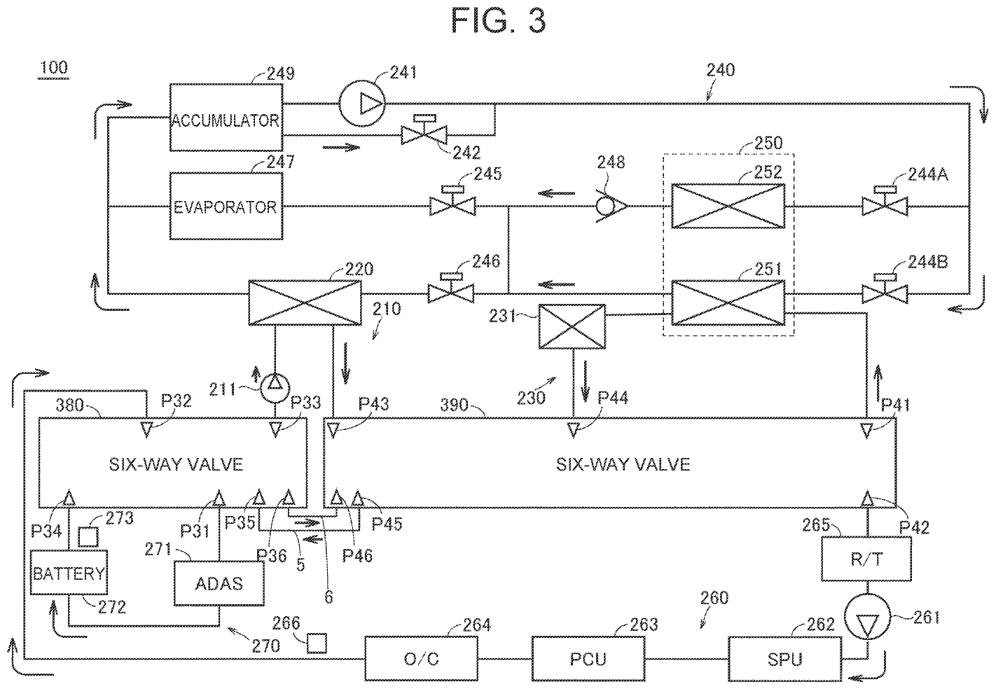

The radiator circuit 230 includes a radiator 231. The refrigeration cycle 240 includes, for example, a compressor 241, a solenoid valve 242, solenoid valves 244A, 244B, 245, 246 (see FIG. 3), an evaporator 247, a check valve 248, and an accumulator 249. The condenser 250 includes a water-cooled condenser 251 and an air-cooled condenser 252 (see FIG. 3), and the water-cooled condenser 251 is connected to both of the refrigeration cycle 240 and the radiator circuit 230.

The driving unit circuit 260 includes, for example, a water pump 261, a smart power unit (SPU) 262, a power control unit (PCU) 263, an oil cooler (O/C) 264, a reservoir tank 265, and a heat medium temperature sensor 266. Instead of the oil cooler 264, a transaxle may be provided in the driving unit circuit 260. An eAxle combining the PCU 263 and the oil cooler 264 (or a transaxle) may be installed. The PCU 263 and the oil cooler 264 are examples of “driving device” of this disclosure.

The battery circuit 270 includes, for example, an advanced driver-assistance system (ADAS) 271, the battery 272, and a battery temperature sensor 273. The battery 272 is one example of “electrical storage device” of this disclosure. The battery temperature sensor 273 is one example of “first temperature sensor.” A ripple temperature raising circuit that raises the temperature of the battery 272 by a ripple component of a current flowing through the battery 272 may be provided in the battery circuit 270 (battery 272).

The six-way valve 380 includes six ports P31 to P36 (see FIG. 3). The six-way valve 390 includes six ports P41 to P46 (see FIG. 3). The six-way valve 380 is connected to the chiller circuit 210, the driving unit circuit 260, and the battery circuit 270. The six-way valve 390 is connected to the chiller circuit 210, the driving unit circuit 260, and the radiator circuit 230.

The chiller 220 is provided in a flow passage 210b of the chiller circuit 210. The flow passage 210b is provided so as to connect the chiller circuit 210 to each of the six-way valve 380 and the six-way valve 390. In the chiller 220, a heat medium flowing through the flow passage 210b and a heat medium circulating through the refrigeration cycle 240 exchange heat with each other. The flow passage 210b is one example of “fourth flow passage” of this disclosure.

The radiator 231 is provided in a flow passage 230c. The flow passage 230c is provided so as to connect the radiator 231 and the six-way valve 390 to each other. In the radiator 231, a heat medium flowing through the flow passage 230c and outside air exchange heat with each other. The flow passage 230c is one example of “third flow passage” of this disclosure.

The water pump 261, the SPU 262, the PCU 263, the oil cooler 264, and the reservoir tank 265 are provided in a flow passage 260b of the driving unit circuit 260. The flow passage 260b is provided so as to connect the driving unit circuit 260 to each of the six-way valve 380 and the six-way valve 390. The PCU 263, the oil cooler 264, etc. exchange heat with (a heat medium in) the flow passage 260b. The flow passage 260b is in thermal contact with the SPU 262, the PCU 263, and the oil cooler 264. The flow passage 260b is one example of “second flow passage” of this disclosure.

The battery 272 is provided in a flow passage 270b of the battery circuit 270. The flow passage 270b is provided so as to connect the battery circuit 270 and the six-way valve 380 to each other. The battery 272 exchanges heat with (a heat medium in) the flow passage 270b. The flow passage 270b is in thermal contact with the battery 272. The flow passage 270b is one example of “first flow passage” of this disclosure.

The ECU 500 controls the heat management circuit 100. The ECU 500 includes a processor 501, a memory 502, a storage 503, and an interface 504.

The processor 501 is, for example, a central processing unit (CPU) or a micro-processing unit (MPU). The memory 502 is, for example, a random-access memory (RAM). The storage 503 is a rewritable non-volatile memory, such as a hard disk drive (HDD), a solid-stage drive (SSD), or a flash memory. In the storage 503, system programs including an operating system (OS), and control programs including computer-readable codes required for control calculations are stored. The processor 501 realizes various processes by retrieving the system programs and the control programs and developing and executing these programs in the memory 502. The interface 504 controls communication between the ECU 500 and components of the heat management circuit 100.

The ECU 500 generates a control command based on sensor values acquired from various sensors included in the heat management circuit 100 (e.g., the battery temperature sensor 273 and the heat medium temperature sensor 266), user operation received by the HMI 600, etc., and outputs the generated control command to the heat management circuit 100. The ECU 500 may be divided into a plurality of ECUs by function. While an example in which the ECU 500 includes one processor 501 is shown in FIG. 2, the ECU 500 may include a plurality of processors. The same applies to the memory 502 and the storage 503.

In this Description, “processor” is not limited to a processor in a narrow sense that executes processes by a stored-program method, but can include a hard-wired circuits, such as an application-specific integrated circuit (ASIC) or a field-programmable gate array (FPGA). Therefore, the term “processor” can be read as a processing circuitry in which processes are defined in advance by a computer-readable code and/or a hard-wired circuit.

The HMI 600 is a display with a touch panel, an operation panel, a console, or the like. The HMI 600 receives user operation for controlling the heat management system 1. The HMI 600 outputs a signal indicating user operation to the ECU 500.

### Configuration of Heat Management Circuit

FIG. 3 is a diagram showing one example of the configuration of the heat management circuit 100 in this embodiment. A heat medium circulating through the chiller circuit 210 flows through a route leading from the six-way valve 380 (port P33) to the water pump 211 to the chiller 220 to the six-way valve 390 (port P43).

The water pump 211 circulates the heat medium inside the chiller circuit 210 in accordance with a control command from the ECU 500. In the chiller 220, heat is exchanged between the heat medium circulating through the chiller circuit 210 and the heat medium circulating through the refrigeration cycle 240. Each of the six-way valve 380 and the six-way valve 390 switches a route to which the chiller circuit 210 is connected in accordance with a control command from the ECU 500. Switching of the route by the six-way valve 380 and the six-way valve 390 will be described in detail later.

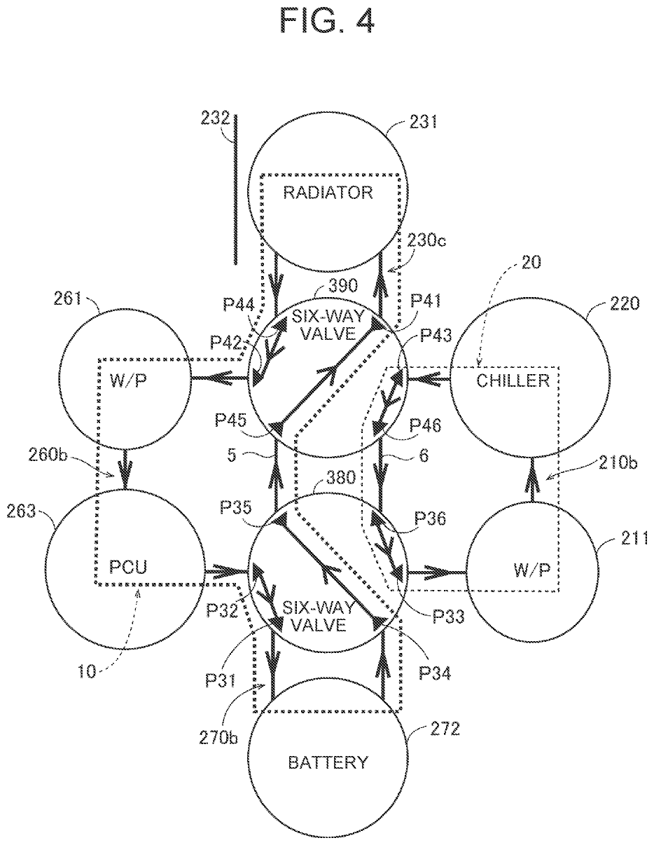

The heat medium circulating through the radiator circuit 230 flows from the six-way valve 390 (port P41) to the water-cooled condenser 251 to the radiator 231 to the six-way valve 390 (port P44). The radiator 231 is disposed downstream of a grille shutter 232 (sec FIG. 4) and exchanges heat between air outside the vehicle and the heat medium. The grille shutter 232 is configured to adjust the amount of heat released from the radiator 231 to the outside of the electrified vehicle 1a. The ECU 500 controls opening and closing of the grille shutter 232 based on sensor values acquired from various sensors included in the heat management circuit 100 (e.g., the battery temperature sensor 273 and the heat medium temperature sensor 266).

The heat medium (a gas-phase refrigerant or a liquid-phase refrigerant) circulating through the refrigeration cycle 240 flows through one of the following routes: a first route leading from the compressor 241 to the solenoid valve 244A to the air-cooled condenser 252 to the check valve 248 to the solenoid valve (expansion valve) 245 to the evaporator 247 to the accumulator 249 to the compressor 241; a second route leading from the compressor 241 to the solenoid valve 244A to the air-cooled condenser 252 to the check valve 248 to the solenoid valve (expansion valve) 246 to the chiller 220 to the accumulator 249 to the compressor 241; a third route leading from the compressor 241 to the solenoid valve 244B to the water-cooled condenser 251 to the solenoid valve (expansion valve) 245 to the evaporator 247 to the accumulator 249 to the compressor 241; and a fourth route leading from the compressor 241 to the solenoid valve 244B to the water-cooled condenser 251 to the solenoid valve 246 to the chiller 220 to the accumulator 249 to the compressor 241.

The compressor 241 compresses the gas-phase refrigerant circulating through the refrigeration cycle 240 in accordance with a control command from the ECU 500. The solenoid valve 242 is connected in parallel to the compressor 241, and adjusts the amount of gas-phase refrigerant flowing into the compressor 241 in accordance with a control command from the ECU 500. The solenoid valves 244A, 244B switch the gas-phase refrigerant discharged from the compressor 241 between flowing into the water-cooled condenser 251 and flowing into the air-cooled condenser 252 in accordance with a control command from the ECU 500. The water-cooled condenser 251 makes the gas-phase refrigerant discharged from the compressor 241 and the heat medium flowing through the radiator circuit 230 exchange heat with each other. The air-cooled condenser 252 exchanges heat with air introduced into a vehicle cabin to create a warm wind. The solenoid valve 245 restricts inflow of the liquid-phase refrigerant into the evaporator 247 in accordance with a control command from the ECU 500. The solenoid valve 246 restricts inflow of the liquid-phase refrigerant into the chiller 220 in accordance with a control command from the ECU 500. The solenoid valves 245, 246 function also to expand the liquid-phase refrigerant. The accumulator 249 removes the liquid-phase refrigerant from the refrigerant in a state of a gas-liquid mixture, and when the refrigerant fails to be completely gasified by the evaporator 247, prevents the liquid-phase refrigerant from being suctioned into the compressor 241.

The heat medium (coolant) circulating through the driving unit circuit 260 flows through a route leading from the six-way valve 390 (port P42) to the reservoir tank 265 to the water pump 261 to the SPU 262 to the PCU 263 to the oil cooler 264 to the six-way valve 380 (port P32).

The water pump 261 circulates the heat medium inside the driving unit circuit 260 in accordance with a control command from the ECU 500. The SPU 262 controls charging and discharging of the battery 272 in accordance with a control command from the ECU 500. The PCU 263 converts direct-current power supplied from the battery 272 into alternating-current power in accordance with a control command from the ECU 500 and supplies this alternating-current power to a motor (not shown) incorporated in the transaxle. The oil cooler 264 cools the transaxle through heat exchange between the heat medium circulating through the driving unit circuit 260 and lubricating oil of the motor. Heat may be exchanged between heat that is generated as electricity is supplied to a stator of the motor without a rotor of the motor being rotated and the heating medium circulating through the driving unit circuit 260.

The SPU 262, the PCU 263, and the oil cooler 264 are cooled by the heat medium circulating through the driving unit circuit 260. The reservoir tank 265 maintains the pressure and the amount of the heat medium inside the driving unit circuit 260 by storing part of the heat medium inside the driving unit circuit 260 (the heat medium that has overflowed as the pressure rose).

The heat medium temperature sensor 266 detects the temperature of the heat medium in the flow passage 260b in which the PCU 263 etc. are provided. For example, the heat medium temperature sensor 266 detects the temperature of the heat medium flowing between the oil cooler 264 and the six-way valve 380 (on a downstream side of the oil cooler 264). The heat medium temperature sensor 266 may detect the temperature of the heat medium, for example, between the PCU 263 and the oil cooler 264.

The heat medium (coolant) circulating through the battery circuit 270 flows through a route leading from the six-way valve 380 (port P31) to the ADAS 271 to the battery 272 to the six-way valve 380 (port P34).

The ADAS 271 includes, for example, an adaptive cruise control (ACC), an auto speed limiter (ASL), a lane keeping assist (LKA), a pre-crash safety (PCS), and a lane departure alert (LDA). The battery circuit 270 may include an autonomous driving system (ADS) in addition to the ADAS 271. The battery 272 supplies electricity for traveling to the motor incorporated in the transaxle. The battery temperature sensor 273 detects the temperature of the battery 272.

### Communication Pattern

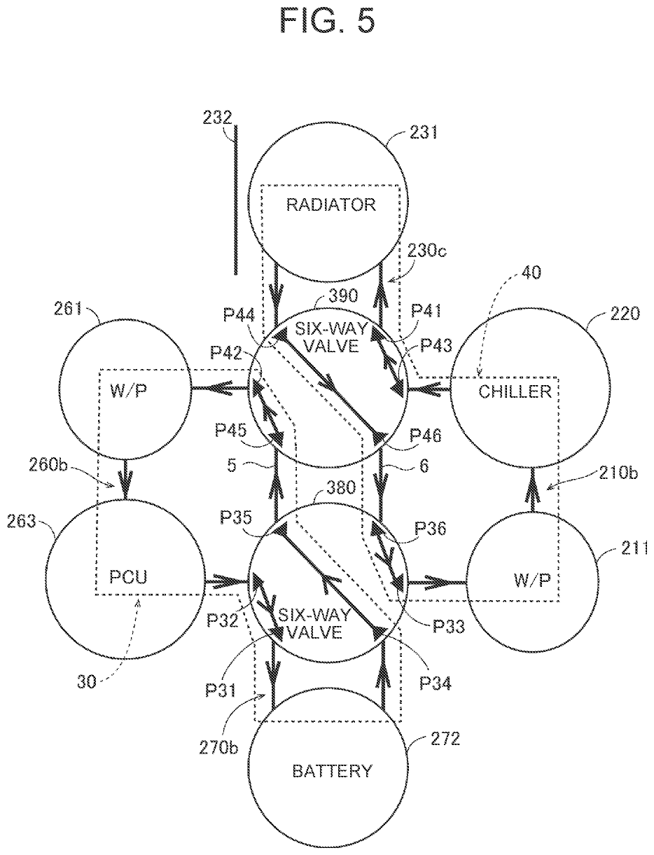

FIG. 4 and FIG. 5 are conceptual views showing overviews of first and second communication patterns, respectively, of the heat management circuit 100 that are formed by controlling the six-way valve 380 and the six-way valve 390. The first communication pattern is one example of “temperature raising circuit” of this disclosure.

In the first communication pattern shown in FIG. 4, a route that allows communication between the port P31 and the port P32, a route that allows communication between the port P34 and the port P35, and a route that allows communication between the port P33 and the port P36 are formed by the six-way valve 380.

In the first communication pattern, a route that allows communication between the port P42 and the port P44, a route that allows communication between the port P41 and the port P45, and a route that allows communication between the port P43 and the port P46 are formed by the six-way valve 390.

Further, in the first communication pattern, a route that allows communication between the port P35 and the port P45 (flow passage 5) and a route that allows communication between the port P36 and the port P46 (flow passage 6) are formed.

Thus, the flow passage 260b in which the PCU 263 etc. are provided, the flow passage 230c in which the radiator 231 is provided, the flow passage 270b in which the battery 272 is provided, the six-way valve 380, and the six-way valve 390 are connected to one another. As a result, the heat medium flows through a first closed circuit 10 leading from the water pump 261 to the PCU 263 to the six-way valve 380 to the battery 272 to the six-way valve 380 to the six-way valve 390 to the radiator 231 to the six-way valve 390 to the water pump 261. The first closed circuit 10 is one example of “connection flow passage” of this disclosure.

Further, the flow passage 210b in which the chiller 220 is provided, the six-way valve 380, and the six-way valve 390 are connected to one another. As a result, the heat medium circulates through a second closed circuit 20 leading from the water pump 211 to the chiller 220 to the six-way valve 390 to the six-way valve 380 to the water pump 211.

In the example shown in FIG. 4, the first closed circuit 10 and the second closed circuit 20 (flow passage 210b) are disconnected from and independent of each other.

In the second communication pattern shown in FIG. 5, a route that allows communication between the port P32 and the port P31, a route that allows communication between the port P34 and the port P35, and a route that allows communication between the port P33 and the port P36 are formed by the six-way valve 380.

In the second communication pattern, a route that allows communication between the port P42 and the port P45, a route that allows communication between the port P44 and the port P46, and a route that allows communication between the port P41 and the port P43 are formed by the six-way valve 390.

Further, in the second communication pattern, the route that allows communication between the port P35 and the port P45 (flow passage 5) and the route that allows communication between the port P36 and the port P46 (flow passage 6) are formed.

Thus, the flow passage 260b in which the PCU 263 etc. are provided, the flow passage 270b in which the battery 272 is provided, the six-way valve 380, and the six-way valve 390 are connected to one another. As a result, the heat medium flows through a third closed circuit 30 leading from the water pump 261 to the PCU 263 to the six-way valve 380 to the battery 272 to the six-way valve 380 to the six-way valve 390 to the water pump 261.

Further, the flow passage 210b in which the chiller 220 is provided, the flow passage 230c in which the radiator 231 is provided, the six-way valve 380, and the six-way valve 390 are connected to one another. As a result, the heat medium flows through a fourth closed circuit 40 leading from the water pump 211 to the chiller 220 to the six-way valve 390 to the radiator 231 to the six-way valve 390 to the six-way valve 380 to the water pump 211. The third closed circuit 30 and the fourth closed circuit 40 are disconnected from and independent of each other.

### Control Method of Heat Management Circuit

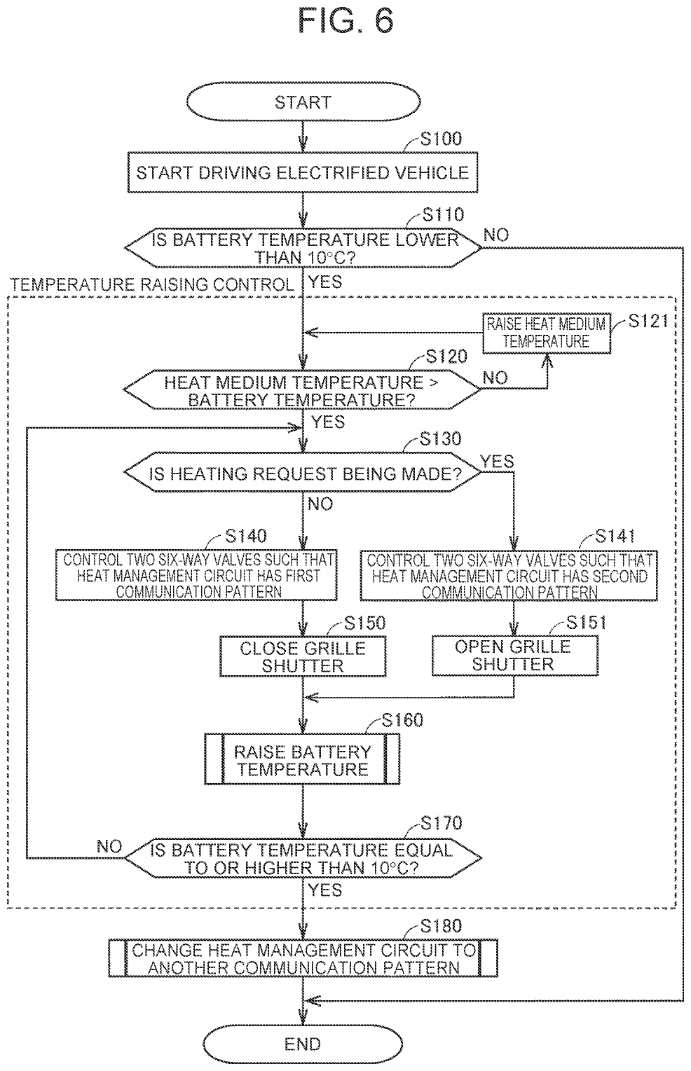

A control method of the heat management system 1 will be described with reference to the flowchart of FIG. 6. The flowchart described below is merely one example, and this disclosure is not limited to this example.

In step S100, driving of the electrified vehicle 1a is started (a travel system is started). Specifically, a start button (not shown) of the electrified vehicle 1a is pressed down, and the PCU 263 etc. are driven and the PCU 263 and the battery 272 are electrically connected to each other (by the SMR (not shown)). Thus, a current is supplied from the PCU 263 to the battery 272. The ECU 500 detects that driving of the electrified vehicle 1a has been started by receiving a predetermined internal signal in the electrified vehicle 1a.

In step S110, the ECU 500 determines whether the temperature of the battery 272 detected by the battery temperature sensor 273 is lower than 10° C. When the temperature of the battery 272 is lower than 10° C. (Yes in S110), the process moves to step S120. When the temperature of the battery 272 is equal to or higher than 10° C. (No in S110), the process ends. The threshold value in step S110 may be a numeral value other than 10° C.

In step S120, the ECU 500 determines whether the temperature of the heat medium detected by the heat medium temperature sensor 266 is higher than the temperature of the battery 272 detected by the battery temperature sensor 273. When the temperature of the heat medium is higher than the temperature of the battery 272 (Yes in S120), the process moves to step S130. When the temperature of the heat medium is equal to or lower than the temperature of the battery 272 (No in S120), the process moves to step S121.

In step S121, the ECU 500 performs control of raising the temperature of the heat medium flowing through the flow passage 130b. Specifically, the ECU 500 makes the heat medium flow for a predetermined time in a state where the PCU 133 etc. are driven. Thus, the temperature of the heat medium is raised by heat generated from the PCU 133 etc. Next, the process returns to step S120.

In step S130, the ECU 500 determines whether a user of the electrified vehicle 1a is requesting heating to be turned on. When this request is not being made (No in S130), the process moves to step S140. When this request is being made (Yes in S130), the process moves to step S141. The ECU 500 may determine whether this request is being made based on a signal that is sent to the ECU 500 when the user presses down a button for turning heating on.

In step S140, the ECU 500 controls each of the six-way valve 380 and the six-way valve 390 such that the heat management circuit 100 has the first communication pattern shown in FIG. 4. In this case, the ECU 500 may stop the water pump 211. Next, the process moves to step S150.

In step S141, the ECU 500 controls each of the six-way valve 380 and the six-way valve 390 such that the heat management circuit 100 has the second communication pattern shown in FIG. 5. In this case, the ECU 500 activates the water pump 211. In step S141, the ECU 500 may form the second communication pattern under the condition that the outside air temperature is, for example, equal to or higher than −10° C. Next, the process moves to step S151.

In step S150, the ECU 500 controls the grille shutter 232 so as to be in a closed state. Next, the process moves to step S160.

In step S151, the ECU 500 controls the grille shutter 232 so as to be in an open state. Next, the process moves to step S160.

In step S160, the ECU 500 raises the temperature of the battery 272 by continuing the state where the first communication pattern or the second communication pattern is formed. The detailed process executed in step S160 will be described later.

In step S170, the ECU 500 determines whether the temperature of the battery 272 detected by the battery temperature sensor 273 is equal to or higher than 10° C. When the temperature of the battery 272 is equal to or higher than 10° C. (Yes in S170), the process moves to step S180. When the temperature of the battery 272 is lower than 10° C. (No in S170), the process returns to step S130. The threshold value in step S170 may be any numerical value other than 10° C. as long as it is equal to or larger than the threshold value in step S110. The process from step S120 to S170 is one example of “temperature raising control” of this disclosure.

In step S180, the ECU 500 controls each of the six-way valve 380 and the six-way valve 390 so as to change the communication pattern of the heat management circuit 100 from the first communication pattern shown in FIG. 4 (or the second communication pattern shown in FIG. 5) to another communication pattern (e.g., a communication pattern suitable for travel of the electrified vehicle 1a). Thereafter, the process ends. A process after the communication pattern is changed in step S180 will be described later.

### Process in S160

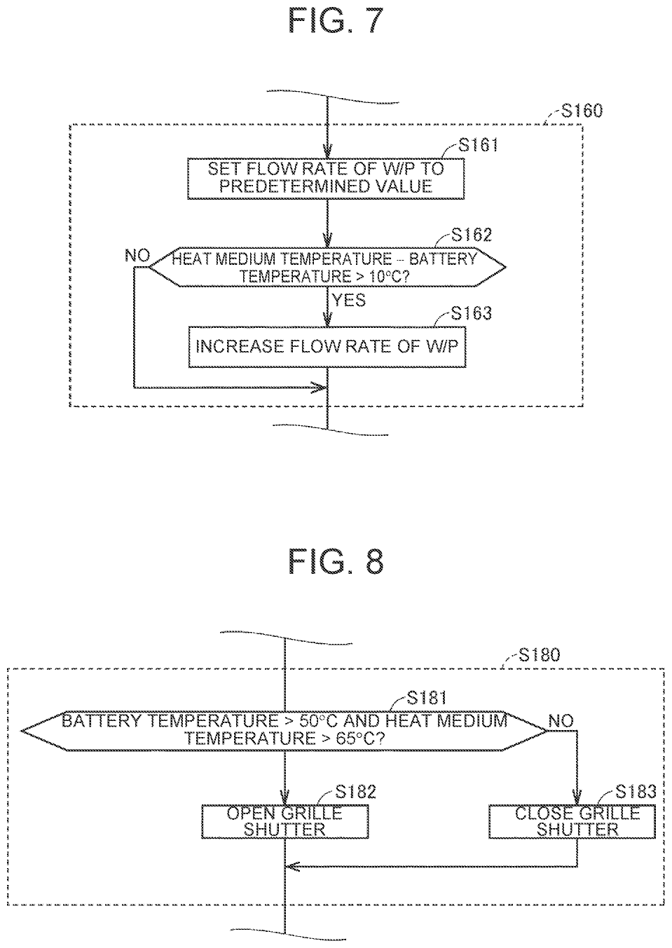

As shown in FIG. 7, the process of step S160 includes a process from step S161 to S163. In step S161, the ECU 500 sets the flow rate (output) of the water pump 261 to a predetermined value (initial setting). This predetermined value is a relatively low value (e.g., about one-quarter of an upper limit value) in a flow rate range in which the water pump 261 is capable of outputting. The process of step S161 is executed only in the first flow.

In step S162, the ECU 500 determines whether the difference between the temperature of the heat medium detected by the heat medium temperature sensor 266 and the temperature of the battery 272 detected by the battery temperature sensor 273 has exceeded 10° C. (the temperature of the heat medium-the temperature of the battery 272>10° C.) as time has passed from the start of the temperature raising control. When this difference is larger than 10° C. (Yes in S162), the process moves to step S163. When this difference is equal to or smaller than 10° C. (No in S162), the process moves to step S170 (see FIG. 6). The temperature of the heat medium rises faster than the temperature of the battery 272. Accordingly, during the temperature raising control of the battery 272, the aforementioned difference becomes gradually larger as time passes.

In step S163, the ECU 500 increases the flow rate (output) of the water pump 261. For example, the ECU 500 sets the flow rate (output) of the water pump 261 to the upper limit value in the flow rate range in which the water pump 261 is capable of outputting. Thus, during the temperature raising control of the battery 272, the flow rate (output) of the water pump 261 is increased as the aforementioned difference (the difference between the temperature of the heat medium and the temperature of the battery 272) increases with the passage of time. Next, the process moves to step S170 (see FIG. 6). In step S163, when the flow rate (output) of the water pump 261 has already been set to the upper limit value, the flow rate (output) of the water pump 261 is not changed.

While the example in which the process of step S163 is executed based on the difference between the temperature of the heat medium and the temperature of the battery 272 has been shown above, this disclosure is not limited thereto. For example, the process of step S163 may be performed based on passage of a predetermined time (e.g., 10 minutes) after the process of step S161 is performed. In this case, therefore, the aforementioned difference is not taken into account.

While the example in which the flow rate (output) of the water pump 261 is increased to a predetermined value based on the aforementioned difference in step S163 has been shown, this disclosure is not limited thereto. For example, the ECU 500 may determine the flow rate (output) of the water pump 261 based on the temperature of the heat medium detected by the heat medium temperature sensor 266 and a required value of the flow rate of the heat medium. The ECU 500 may set the flow rate (output) using a map that shows a relationship between the temperature of the heat medium and the required value of the flow rate of the heat medium on one side and the flow rate (output) of the water pump 261 on the other. This map is stored, for example, in the memory 502 (see FIG. 2).

### Process in S180

As shown in FIG. 8, the process of step S180 includes a process from step S181 to S183. The process of step S180 may be executed once every predetermined time.

In step S181, the ECU 500 determines whether the temperature of the battery 272 detected by the battery temperature sensor 273 is higher than 50° C. as well as the temperature of the heat medium detected by the heat medium temperature sensor 266 is higher than 65° C. When the result of step S181 is Yes, the process moves to step S182. When the result of step S181 is No, the process moves to step S183. Each of these threshold values 50° C. and 65° C. may be another value.

In step S182, the ECU 500 controls the grille shutter 232 (see FIG. 4) so as to be in the open state. When the grille shutter 232 is already in the open state, this open state is maintained.

In step S183, the ECU 500 controls the grille shutter 232 (see FIG. 4) so as to be in the closed state. When the grille shutter 232 is already in the closed state, this closed state is maintained.

As has been described above, in this embodiment, the ECU 500 controls the six-way valve 380 and the six-way valve 390 during the temperature raising control of the battery 272 such that the second closed circuit 20 (flow passage 210b) becomes disconnected from and independent of the first closed circuit 10 (the flow passage 270b, the flow passage 260b, and the flow passage 230c). Thus, heat due to heat generation of the battery 272 by itself and heat due to heat generation of the PCU 263 etc. are less likely to be taken away by the chiller 220. As a result, it is possible to efficiently execute temperature raising of the battery 272 while allowing effective utilization of heat generated from the PCU 263 etc.

Since the radiator 231 is included in the first closed circuit 10, compared with when the radiator 231 is not included in the first closed circuit 10, an extra amount of heat corresponding to the heat capacity of the radiator 231 can be accumulated (stored) in the first closed circuit 10. As a result, in a case such as where heating is turned on with the radiator 231 and the chiller 220 connected to each other, the heat accumulated (stored) in the first closed circuit 10 (radiator 231) can be utilized for heating. Thus, heating can be efficiently turned on.

While the example in which the temperature raising control of the battery 272 is performed after the start of driving of the electrified vehicle 1a (after the start-up of the travel system) has been shown in the above-described embodiment, this disclosure is not limited thereto. The temperature raising control may be started based on it being a predetermined time (e.g., 30 minutes) before a scheduled time of starting to travel next time. In such a case, control that does not generate torque in the motor of the electrified vehicle 1a (e.g., control in which only one-phase current among three-phase currents supplied to the motor is passed) may be performed.

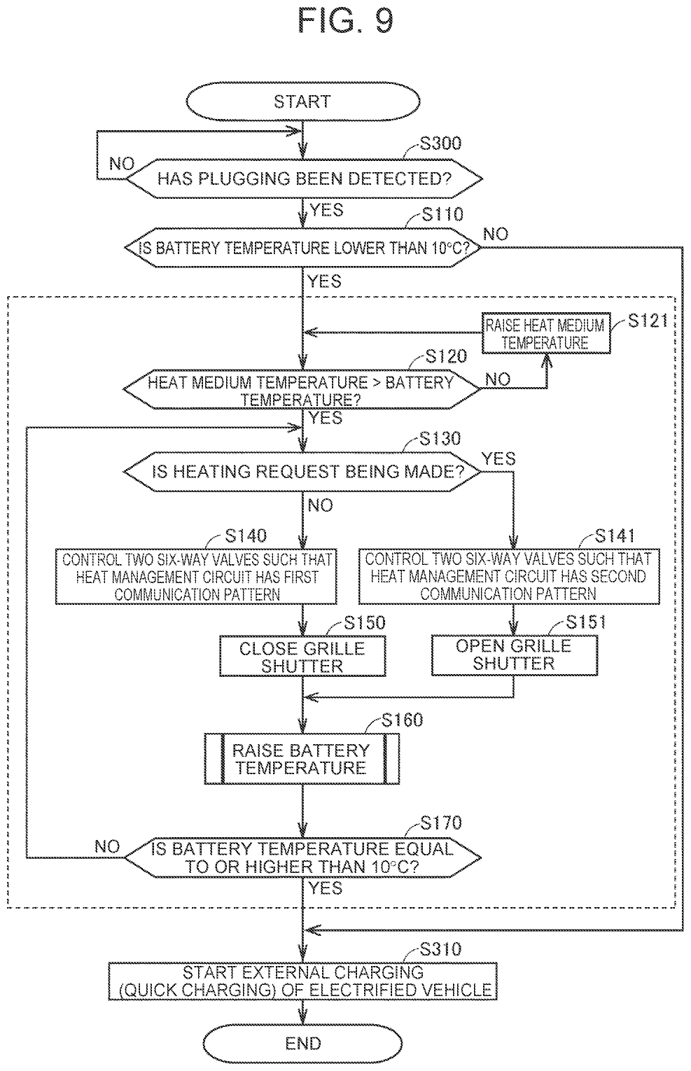

Further, as shown in FIG. 9, the temperature raising control may be executed at the start of external charging (e.g., quick charging) in which the battery is charged using charging electricity supplied from a charging facility (not shown) outside the electrified vehicle. For example, upon detection of plugging of a charging plug by the ECU 500 in step S300, the process moves to step S110. When it is determined in step S170 or S110 that the temperature of the battery 173 is equal to or higher than 10° C., the process moves to step S310. 10° C. is one example of “predetermined temperature” of this disclosure. In step S310, the ECU 500 starts control of external charging (quick charging). While the example in which plugging serves as a trigger of the battery temperature raising control has been depicted in FIG. 9, the battery temperature raising control may be started also before plugging, for example, upon reaching a point in a predetermined time (e.g., 10 minutes) before a scheduled time of starting external charging (starting to supply charging electricity). Or the temperature raising control may be executed at the start of normal charging (low-speed charging with lower charging speed than quick charging).

While the example in which the heat management system 1 is provided in the electrified vehicle 1a has been shown in the above-described embodiment, this disclosure is not limited thereto. The heat management system 1 may be provided in electrical apparatus different from the electrified vehicle 1a (e.g., a stationary electrical storage device).

While the example in which the first communication pattern is formed and the temperature raising control of the battery 272 is performed when the temperature of the flow passage 260c (second flow passage) in which the PCU 263 etc. are provided is higher than the temperature of the battery 272 has been shown in the above-described embodiment, this disclosure is not limited thereto. The first communication pattern may be formed at a point when the temperature of the flow passage 260c is equal to or lower than the temperature of the battery 272. The first communication pattern may be formed and the temperature raising control of the battery 272 may be performed, for example, based only on the temperature of the battery 272, regardless of the relationship between the temperature of the heat medium and the temperature of the battery 272.

While the example in which the output of the water pump 261 is increased as time passes has been shown in the above-described embodiment, this disclosure is not limited thereto. For example, the output of the water pump 261 may be constant.

While the example in which the first communication pattern and the second communication pattern are switched based on whether a heating request is being made has been shown in the above-described embodiment, this disclosure is not limited thereto. The first communication pattern may be formed and the temperature raising control of the battery 272 may be performed regardless of whether a heating request is being made. In this case, for example, the heat of a heater disposed in the flow passage 210b in which the chiller 220 is provided may be used when heating is turned on.

While the example in which the output of the water pump 261 is increased to the predetermined value (upper limit value) when the difference between the temperature of the heat medium and the temperature of the battery 272 exceeds the predetermined threshold value has been shown in the above-described embodiment, this disclosure is not limited thereto. For example, the output of the water pump 261 may be gradually increased according to (in proportion to) an increase in this difference. The output of the water pump 261 may be increased to the predetermined value a predetermined time (e.g., 10 minutes) after the temperature raising control in the state where the first (second) communication pattern is formed is started.

While the example in which the temperature raising control of the battery 272 is performed after the start of driving of the electrified vehicle 1a (after the start-up of the travel system) has been shown in the above-described embodiment, this disclosure is not limited thereto. For example, the temperature raising control may be performed also at times other than after the start of driving of the electrified vehicle 1a (after the start-up of the travel system), when the temperature of the battery 272 becomes lower than a predetermined threshold value (10° C. in the above-described embodiment). In this case, the ECU 500 may acquire a detection value of the temperature of the battery 272 on a predetermined cycle (e.g., once every hour).

While the example in which the first communication pattern (temperature raising circuit) is formed after the start of driving of the electrified vehicle 1a (after the start-up of the travel system) and the temperature of the battery 272 is raised using a current flowing through the battery 272 has been shown in the above-described embodiment, this disclosure is not limited thereto. For example, the first communication pattern may be formed after travel of the electrified vehicle 1a ends (after a current stops flowing through the battery 272) and the temperature of the battery 272 may be raised using the heat medium of which the temperature has been raised due to heat generation of the PCU 263 etc. The temperature of the battery may be raised by passing a higher current than at normal times to the battery in a state where the first communication pattern is formed during travel of the electrified vehicle 1a.

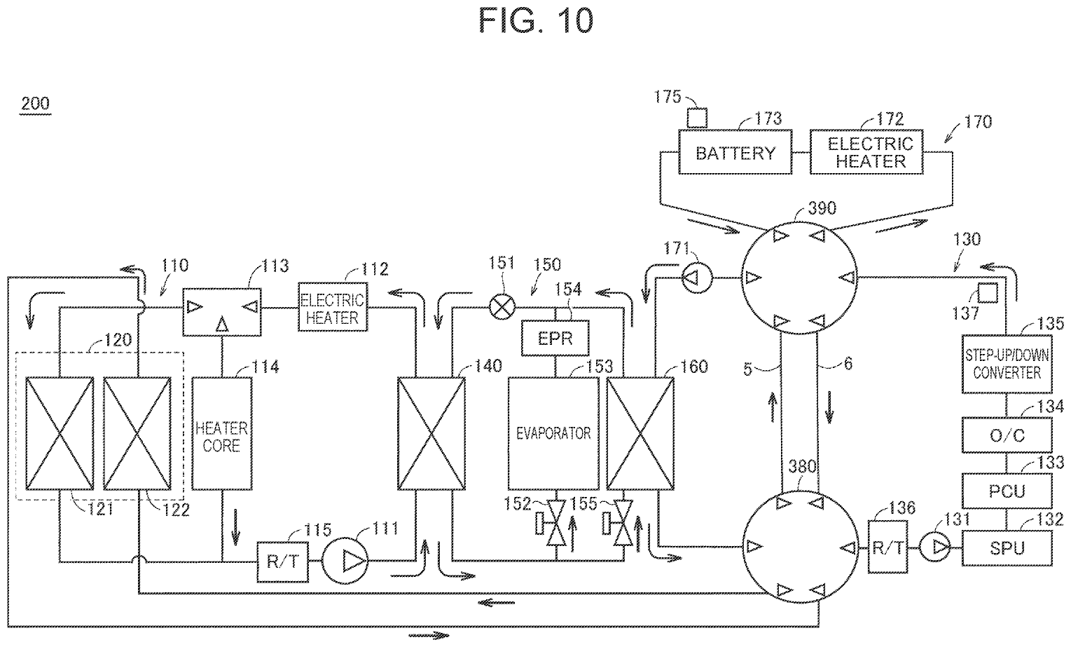

In a heat management circuit provided with the six-way valve 380 and the six-way valve 390 as in the above-described embodiment, a high-temperature circuit 110 as shown in FIG. 10 may be provided. Specifically, a heat management circuit 200 includes, for example, the high-temperature circuit 110, a radiator 120, a low-temperature circuit 130, a condenser 140, a refrigeration cycle 150, a chiller 160, a battery circuit 170, the six-way valve 380, and the six-way valve 390. The chiller 160 is one example of “chiller device” of this disclosure.

The high-temperature circuit 110 includes, for example, a water pump (W/P) 111, an electric heater 112, a three-way valve 113, a heater core 114, and a reservoir tank (R/T) 115. The heater core 114 is one example of “air conditioning circuit” of this disclosure.

The radiator 120 includes a high-temperature (HT) radiator 121 and a low-temperature (LT) radiator 122. The low-temperature radiator 122 is one example of “radiator” of this disclosure.

The low-temperature circuit 130 includes, for example, a water pump 131, an SPU 132, a PCU 133, an oil cooler 134, a step-up/down converter 135, a reservoir tank 136, and a heat medium temperature sensor 137. The PCU 133 and the oil cooler 134 are examples of “driving device” of this disclosure. The water pump 131 and the heat medium temperature sensor 137 are examples of “pump” and “second temperature sensor,” respectively, of this disclosure.

The refrigeration cycle 150 includes, for example, a compressor 151, an evaporation valve 152, an evaporator 153, an evaporative pressure regulator (EPR) 154, and an expansion valve 155.

The battery circuit 170 includes, for example, a water pump 171, an electric heater 172, a battery 173, and a battery temperature sensor 175. The battery 173 and the battery temperature sensor 175 are examples of “electrical storage device” and “first temperature sensor,” respectively, of this disclosure.

The configurations (processes) of the above-described embodiment and those of the above-described modified examples may be combined with each other.

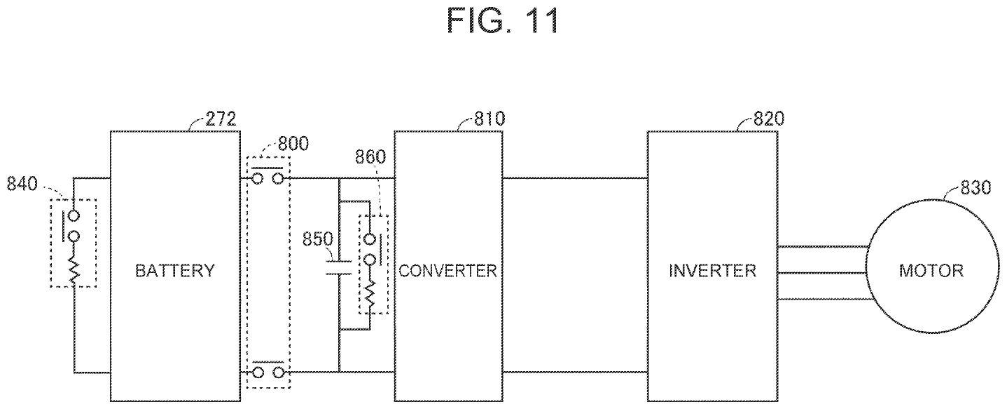

Details of battery temperature raising control will be described with reference to FIG. 11. The battery 272 is connected to a converter 810 through a system main relay (SMR) 800. The converter 810 is connected to an inverter 820. The inverter 820 is connected to a motor 830. A discharging circuit 840 including a switch and a resistance element is connected to the battery 272. A smoothing capacitor 850 is provided between the battery 272 and the converter 810. A discharging circuit 860 composed of a switch and a resistance element is connected in parallel to the smoothing capacitor 850.

The temperature raising control of the battery 272 may include control in which the SMR 800 is electrically disconnected and the switch of the discharging circuit 840 is turned on. Thus, a current flows through a closed circuit formed by the battery 272 and the discharging circuit 840. Further, the temperature raising control of the battery 272 may include control in which the switch of the discharging circuit 840 is turned off and the SMR 800 and the switch of the discharging circuit 860 are turned on. Thus, a current flows through a closed circuit formed by the battery 272, the SMR 800, and the discharging circuit 860. In addition, the temperature raising control of the battery 272 may include control in which a current adjusted so as not to generate torque in the motor 830 is passed in a state where the SMR 800 is turned on and the switches of the discharging circuit 840 and the discharging circuit 860 are turned off.

The embodiment disclosed this time should be construed as being in every respect illustrative and not restrictive. The scope of this disclosure is indicated not by the description of the embodiment given above but by the claims, and is intended to include all changes within the meaning and scope of equivalents of the claims.

What is claimed is:

1. A heat management system provided in an electrical apparatus, the heat management system comprising:
a first flow passage, a second flow passage, a third flow passage, and a fourth flow passage configured such that a heat medium flows through the first flow passage, the second flow passage, the third flow passage, and the fourth flow passage;
an electrical storage device configured to perform heat exchange with the heat medium in the first flow passage;
a driving device configured to perform heat exchange with the heat medium in the second flow passage and configured to generate a driving force;
a radiator provided in the third flow passage;
a chiller device provided in the fourth flow passage; and
a switching device configured to switch a connection state among the first flow passage, the second flow passage, the third flow passage, and the fourth flow passage, wherein
when a temperature of the electrical storage device is raised, the switching device is configured to cause a temperature raising circuit to be formed, the temperature raising circuit being a flow passage circuit in which a connection flow passage connecting the first flow passage, the second flow passage, and the third flow passage to one another is provided, with the fourth flow passage being disconnected from and independent of the connection flow passage.

2. The heat management system according to claim 1, wherein:
the electrical apparatus is an electrified vehicle; and
the temperature of the electrical storage device is raised after start-up of a travel system of the electrified vehicle.

3. The heat management system according to claim 1, wherein:
the electrical storage device is configured such that external charging is performed, the external charging being a charging in which the electrical storage device is charged with charging electricity supplied from a charging facility outside the electrical apparatus; and
the temperature of the electrical storage device is raised such that the temperature of the electrical storage device is equal to or higher than a predetermined temperature at start of the external charging.

4. The heat management system according to claim 1, further comprising:
a first temperature sensor configured to detect the temperature of the electrical storage device; and
a second temperature sensor configured to detect a temperature of the heat medium in the second flow passage, wherein
the switching device is configured to cause the temperature raising circuit to be formed, when the temperature of the electrical storage device is raised and a detection value of the second temperature sensor is larger than a detection value of the first temperature sensor.

5. The heat management system according to claim 1, further comprising a pump that is provided in the second flow passage and configured to circulate the heat medium, wherein an output of the pump is increased as time passes when the temperature of the electrical storage device is raised in a state where the temperature raising circuit is provided.

6. The heat management system according to claim 1, wherein:
the electrical apparatus is an electrified vehicle;
the chiller device is configured to exchange heat with an air conditioning circuit that is configured to adjust a temperature in a cabin of the electrified vehicle; and
when there is no request for heating using the air conditioning circuit, the temperature of the electrical storage device is raised in a state where the temperature raising circuit is provided.

7. The heat management system according to claim 2, wherein:
the chiller device is configured to exchange heat with an air conditioning circuit that is configured to adjust a temperature in a cabin of the electrified vehicle; and
when there is no request for heating using the air conditioning circuit, the temperature of the electrical storage device is raised in a state where the temperature raising circuit is provided.

8. The heat management system according to claim 1, further comprising a grille shutter that is configured to open and close and configured to adjust an amount of heat released from the radiator to outside of the electrical apparatus, wherein:
the electrical apparatus is an electrified vehicle; and
the grille shutter is put in a closed state when the temperature of the electrical storage device is raised in a state where the temperature raising circuit is provided.

9. The heat management system according to claim 2, further comprising a grille shutter that is configured to open and close and configured to adjust an amount of heat released from the radiator to outside of the electrified vehicle, wherein the grille shutter is put in a closed state when the temperature of the electrical storage device is raised in a state where the temperature raising circuit is provided.

10. The heat management system according to claim 1, further comprising a control device configured to control the switching device.
